(19) United States
(12) Patent Application Publication
(10) Pub. No.: US 2025/0282330 A1
(43) Pub. Date: Sep. 11, 2025

(54) MOTORIZED CONTROLLER FOR A LANDING GEAR

(71) Applicant: Schafer Industries, LLC, South Bend, IN (US)

(72) Inventors: Michael John EIFERT, Fort Wayne, IN (US); Eric Charles VAN RENS, Chesterfield, MO (US)

(21) Appl. No.: 19/071,484

(22) Filed: Mar. 5, 2025

Related U.S. Application Data
(60) Provisional application No. 63/561,555, filed on Mar. 5, 2024.
(60) Provisional application No. 63/697,994, filed on Sep. 23, 2024.

(51) Int. Cl. B60S 9/04; B60S 9/22

(52) U.S. Cl. CPC B60S 9/04; B60S 9/22

(57) ABSTRACT

A motorized landing gear including: a motor housing that encloses a motor; a gearbox; a controller; and a power source powering the motor and the controller. The gearbox attaches to an axle having two ends, with a first end of the axle connecting to a first landing gear leg and a second end of the axle connecting to a second landing gear leg. The motor connects to said gearbox and the controller instructs the motor to rotate. The rotation of the motor transfers power to the gearbox, which rotates the axle. The rotation of the axle in a first direction simultaneously telescopes the landing gear first leg and the landing gear second leg; and the rotation of the axle in a second direction simultaneously retracts the landing gear first leg and the landing gear second leg.

### CROSS-REFERENCE TO RELATED APPLICATIONS

This application claims benefit of U.S. Provisional Patent Application No. 63/561,555, which was filed on Mar. 5, 2024, and U.S. Provisional Patent Application No. 63/697,994, which was filed on Sep. 23, 2024. The entire disclosure of all the above documents is herein incorporated by reference.

### BACKGROUND OF THE INVENTION

### Field of Invention

This disclosure relates to the field of controllers for landing gear used on truck trailers, campers, and similar objects. In particular, to an electronic, motorized landing gear, and a controller therefor, for a semi-trailer.

### Description of Related Art

Semi-trailers typically lack motorization and are moved through the attachment of a semi-tractor to the front end thereof. In order to facilitate their movement, a semi-trailer will typically comprise a long trailer bed with wheels located on only the back end thereof. The front end of the semi-trailer will generally include a hitch. This is typically a kingpin located under the trailer bed for attachment to a fifth-wheel coupler on the semi-tractor.

In order to provide for open space to allow for coupling of the fifth-wheel to the kingpin, and to provide for easier turning and less friction going down the road, the front end of the semi-trailer typically does not include any wheels. When the fifth-wheel is coupled to the kingpin, the front end of the semi-trailer is supported by the semi-tractor. When the semi-tractor is not attached, such as when the semi-trailer is being stored or awaiting movement, the lack of wheels or other support would cause the semi-trailer to list forward. If the semi-trailer lists forward, it could be near impossible to lift the front end to allow the semi-tractor to pass under the trailer bed and engage the kingpin. This is especially true if the semi-trailer is loaded because a loaded trailer can weigh upwards of 60,000 lbs.

To avoid the listing and associated problems, the front of a semi-trailer will typically utilize two extendible legs, one toward each side of the trailer bed, called a landing gear, which is used to support the front end of the semi-trailer when it is not attached to a semi-tractor. The landing gear is stored in a retracted position, typically behind the rear of the semi-tractor, when the trailer is attached to the semi-tractor. In this retracted position, the landing gear is positioned a relatively substantial distance above the roadway (usually a foot or more) so as to avoid being caught on any small irregularities or obstructions. When the semi-trailer and semi-tractor are to be separated, the landing gear legs are lowered until they contact the surface under the front of the semi-trailer. Extending the landing gear legs provides support for the front end of the semi-trailer so the trailer and tractor can be separated. The landing gear is then locked in place, and the semi-tractor is decoupled. As the front of the semi-trailer is now held aloft by the landing gear, the front does not list downward and, instead, the front essentially remains at exactly the same position it was at before the semi-tractor was decoupled. This typically places it at an appropriate height for another semi-tractor to easily pull up to it and engage the kingpin.

Landing gears have traditionally comprised two rugged legs that can be extended and retracted linearly. This provides the landing gear legs with sufficient strength and also allows the legs to move in a straightforward fashion. Raising and lowering the legs has traditionally, however, been somewhat labor intensive and often has resulted in injury. The two landing gear legs (on opposing sides of the trailer bed) are typically raised and lowered through the use of a large rotary hand crank located on one side of the bed or the other. There is then a large axle that connects the two legs to keep them moving together. The hand crank can be manually rotated in a clockwise or counterclockwise direction to raise or lower the legs.

The use of the hand crank provides the user with a lot of torque and control to raise and lower the legs, however it is a physically demanding process. Using the hand crank to extend the legs when they are in contact with the ground is especially physically demanding, as a fully laden semi-trailer can readily weigh over 60,000 pounds. While situations requiring moving a laden trailer are generally uncommon, they are not unheard of. For instance, the height of the front of the trailer may need to be adjusted to maintain load balance over time, or the height may need to be adjusted to engage a semi-tractor of slightly different dimensions.

In addition to the physical demand rotating the hand crank requires, which can in itself present risk of injury to the user, other risks in hand cranking a landing gear are also prevalent. For instance, when semi-trailers are parked too closely together, the user may not have enough room to position their body properly for cranking the landing gear. This can lead to the user injuring themselves by pulling a muscle or misaligning their back when attempting to exert the force needed to crank the hand crank while their body is in such an abnormal position. Other times, the user may be in a hurry and attempt to crank the gear too quickly, which can lead to the landing gear internals catching or binding, which can, and often does, result in the crank handle recoiling. When the crank handle recoils, there is a significant risk of it impacting the user and causing injury. The binding of the gears that leads to the hand crank handle recoiling can also occur when the trailer is parked on an uneven surface or can be caused from generally poor maintenance of, or damage to, the landing gear internals, even without the user cranking the gear too quickly.

Raising and lowering the legs of the landing gear by hand is simple in theory, but as mentioned, the physical demands, particularly when used in conjunction with a loaded trailer, present a very real likelihood of injury. It would be nice if the legs could be raised and lowered both to initially contact the legs with the ground and to adjust the semi-trailer to a different position in a motorized fashion that does not require the same physical exertion. While a number of systems have been proposed to mechanize or electrify the leg motion, they have all proven to be problematic and, as a result, they have not been uniformly adopted by operators of semi-tractor-trailers.

One example of a prior system is described in U.S. Pat. No. 11,772,947 to Huang (“Huang”), the entire disclosure of which is herein incorporated by reference. The Huang disclosure describes an electric jacking machine and method of using the same. The Huang system, however, is an imperfect solution to the problems with existing landing gears. Specifically, the machine described and disclosed in Huang does not support retrofitting existing landing gears, and instead requires a time consuming and tedious installation of a completely new landing gear (e.g., the Huang machine requires support legs, electric controls, and a power device). Additionally, the Huang landing gear system requires a 24-Volt power supply. Because semi-trailers typically have 12-Volt power supplies, the Huang system cannot be readily used with the semi-trailer power supply and requires a separate battery-pack.

Other systems exist as an alternative to the Huang landing gear. These systems, like the Huang system, are also imperfect solutions to the multitude of problems with existing landing gear systems. Specifically, the existing systems predominately can lift only one leg at a time, which can create torque issues, or require installation of a motorized controller on each landing gear leg, or require an air supply or hydraulics to move the legs. Additionally, the existing systems do not always allow for retrofitting existing landing gears, and instead require installation of a completely new landing gear system, and many of the existing motorized landing gear systems do not provide adequate protection against the extreme elements that are commonly encountered when driving (i.e., snow, ice, sand, high winds, heavy rain, etc.).

Furthermore, the existing systems are not always able to be powered from the 12-Volt semi-tractor power supply, and when they are, they are generally not powerful enough to lift a fully loaded trailer. In fact, there is no existing electronic landing gear system that provides for retrofitting existing landing gears, is compatible with the power supply from the semi-trailer, can lift a loaded trailer, has consistent lift times, does not require a motorized controller on each leg, and can drive both legs of the landing gear at the same time with a single controller.

In addition, the existing electrified landing gear systems, or motorized landing gear systems currently available do not provide adequate safety protections for the device. For instance, when a currently available motorized landing gear system fully extends or retracts the landing gear legs, the legs stop extending or retracting when they hit a mechanical stop, which typically is used to prevent over extension or retraction. However, when this mechanical stop is hit, the shaft or axle that the connects the landing gear legs is often sheared due to the abrupt halt of motion. When this occurs, the shaft or axle must be replaced, which is expensive and time consuming. It would be nice if a system of a motorized landing gear existed that included sufficient safety measures to prevent this axle shear occurrence when the landing gear legs are fully extended or retracted.

Because of these and other problems in the art, there is a need for a system which can be connected to a semi-trailer power supply, if desired, and can provide motorized adjustment of the landing gear legs to both lower the legs to a position where they initially engage the ground from their traveling position while the semi-trailer is still supported by the semi-tractor, and to enable the front of the semi-trailer to be raised and lowered when the front end is freestanding on the landing gear legs.

### SUMMARY OF THE INVENTION

The following is a summary of the invention in order to provide a basic understanding of some aspect of the invention. This summary is not intended to identify key or critical elements of the invention or to delineate the scope of the invention. The sole purpose of this section is to present some concepts of the invention tin a simplified form as a prelude to the more detailed description that is presented later.

Described here in, in an embodiment, there is a motorized landing gear comprising: a motor housing, said motor housing enclosing a motor; a gearbox; a controller; and a power source powering said motor and said controller; said gearbox attaching to an axle having two ends; wherein a first end of said axle connects to a first landing gear leg and a second end of said axle connects to a second landing gear leg; wherein said motor connects to said gearbox; wherein said controller instructs said motor to rotate, said rotation of said motor transfers power to said gearbox to rotate said axle; wherein said rotation of said axle in a first direction simultaneously telescopes said landing gear first leg and said landing gear second leg; and wherein said rotation of said axle in a second direction simultaneously retracts said landing gear first leg and said landing gear second leg.

Also described herein is a method of retro-fitting existing landing gears, the method comprising: providing an existing landing gear comprising a first landing gear leg and a second landing gear leg attached to a semi-trailer; said first landing gear leg and said second landing gear leg connected to first and second ends of an axle, respectively; attaching a gearbox to said axle; connecting a motor to said gearbox, said motor transferring power to said gearbox to rotate said axle; rotating said axle in a first direction to simultaneously telescope said landing gear first leg and said landing gear second leg; and wherein said rotating of said axle in a second direction to simultaneously retract said landing gear first leg and said landing gear second leg.

In an embodiment, cranking a hand crank rotates an axle and telescopes and retracts said landing gear legs.

In an embodiment, the controller instructs said motor to rotate to move said landing gear legs at a variable speed.

In an embodiment, the variable speed increases when said landing gear legs are distal the ground surface and said variable speed decreases when said landing gear legs are proximal the ground surface.

In an embodiment, the controller determines the speed to instruct said motor to rotate based on current draw, torque load, or load weight.

In an embodiment, the controller instructing said motor to rotate at a variable speed includes a prescribed ramp down stop; and wherein said prescribed ramp down stop is initiated when the controller determines the current is greater than a prescribed current upper limit for more than a prescribed time limit with the speed of the motor at 0 RPM.

In an embodiment, the gearbox further comprises use of a differential that levels said landing gear legs on uneven surfaces.

In an embodiment, the power source is supplied from a semi-trailer electrical system.

In an embodiment, the power source is supplied from a solar panel.

In an embodiment, the gearbox is chosen from the group consisting of: a parallel axis gearbox, a planetary gearbox, and right angle gearbox.

### BRIEF DESCRIPTION OF THE DRAWINGS

FIG. 1 provides an overview of an embodiment of the motorized landing gear system of the present disclosure.

FIG. 2 depicts an embodiment of the disclosed motorized landing gear installed centrally on an axle connecting the landing gear legs.

FIG. 3 depicts an embodiment of the disclosed motorized landing gear installed underneath a semi-trailer.

FIG. 4 depicts an embodiment of the disclosed motorized landing gear installed at an end of an axle connecting the landing gear legs.

FIG. 5 depicts an embodiment of the disclose motor housing with the gearbox positioned external the motor housing.

FIG. 6 depicts an embodiment of the disclose motor housing with the gearbox positioned internal the motor housing.

FIG. 7 depicts an embodiment of disclosed motorized landing gear installed at an end of an axle connecting the landing gear legs, better illustrating a connecting element.

FIG. 8 provides an overview of an embodiment of the motorized landing gear system of the present disclosure including two motors and two gearboxes.

FIG. 9 depicts a graphical representation of the disclosed prescribed ramp down stop of an embodiment of the motorized landing gear.

### DETAILED DESCRIPTION OF THE EMBODIMENT(S)

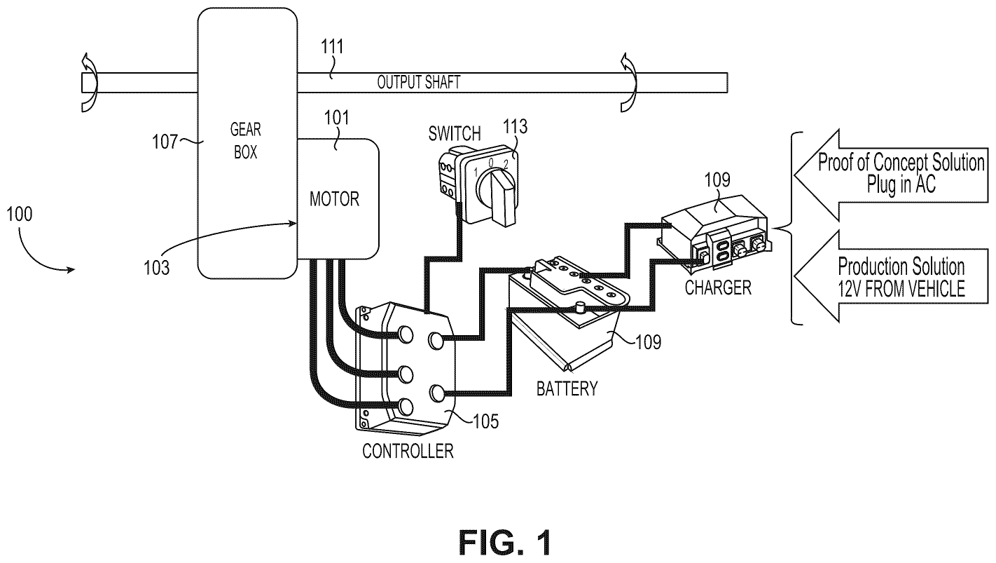

FIG. 1 provides an embodiment of a motorized landing gear (100) of the present disclosure. As depicted in FIG. 1, the motorized landing gear (100) generally comprises a motor (101), motor housing (103), controller (105), gearbox (107), and power source (109). While the system and methods disclosed herein are discussed in conjunction with landing gear on semi-trailers, it should be recognized that in alternative embodiments they can be used on other landing gear systems such as, but not limited to, those on campers, trailers, and other devices. Further, the disclosed systems can be used on trailers or carried objects that may have landing gears but do not actually have any wheels, or on trailers or carried objects that may be removed from their wheels when the landing gears are used.

The disclosed system may operate as either a new system or to retrofit existing landing gear systems. When the disclosed system is operating as a new landing gear system, the system (100) may include new landing gear legs and internal components of the landing gear legs. Although, due to the problems discussed above with installing a new landing gear system, it is contemplated that the disclosed system (100) will preferably be used in retro-fitting applications, which does not require new landing gear legs and, instead, allows integration with the existing landing gear legs (201) and the existing landing gear gearbox (203) and associated internals thereof.

The retro-fitting applications of the disclosed system may be either fully retro-fitting existing landing gears or partially retro-fitting existing landing gear systems. Either a full or partial retro-fit of an existing landing gear system with the disclosed system (100) has unique benefits not currently available with existing landing gear systems. For instance, unlike current electrified landing gear systems, the disclosed system does not interfere with the existing landing gear internals-which may void warranties and create a large project. This is possible because the disclosed systems may connect to the existing landing gear legs (201) in a non-invasive manner, which ensures the legs are not impacted by such retro-fitting. In addition, regardless of if the system is used as a new system or to retro-fit an existing system, the disclosed system will generally allow for the existing manual hand crank (205) to be functional, as described further herein.

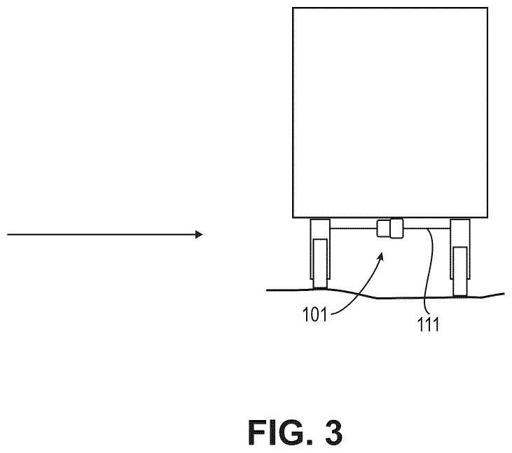

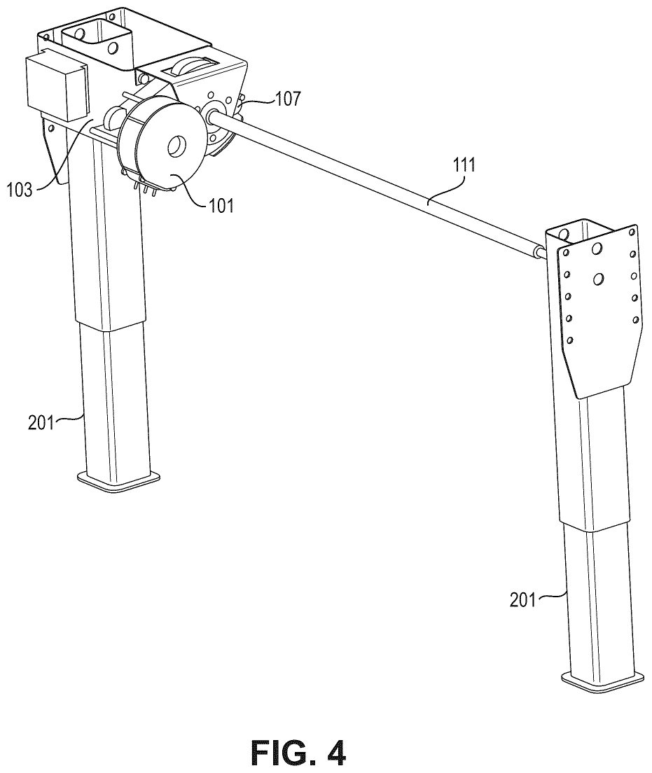

At a high level, the disclosed system may be installed underneath a trailer at either a generally center location between the landing gear legs (201) or in proximity to a landing gear leg (201), as depicted in FIGS. 3 and 4. Depending on the trailer, the needs and circumstances of the user, and/or the system being retro-fitted, the system (100) may be installed and used with a cross bar (or shaft or axle) (111) that has two ends and extends between and connects the two landing gear legs (201). One end of the axle (111) may connect to a first landing gear leg (201) and a second end of the axle (111) may connect to a second landing gear leg (201). Alternatively, the cross bar (111) may be installed and used with a cross bar (111) that is required to be cut in half, with one half of the cross bar (111) attaching at one end to a first landing gear leg (201) and attaching at a second end to one side of a gearbox (107), as described further herein, and the second half of the cross bar (111) attaching at one end to a second landing gear leg (201) and attaching at a second end to a second side of the gearbox (107), with the first side of the gearbox (107) being generally parallel to the second side of the gearbox (107).

The landing gear legs (201) of an embodiment are generally configured to be telescopingly engaged with a landing gear leg housing surrounding the legs, such that the leg may retract and extend from the housing. In an embodiment, the axle (111) engages the landing gear legs (201) via the internal gears of the legs (201) to facilitate retracting and expanding the landing gear legs (201). The retraction and extension (or lowering and raising) of the landing gear legs (201) is generally accomplished by the rotation of the axle (111) as it is engaged with the landing gear legs (201) gears, which in turn may cause the legs to be pushed down to extend from the housing or be pulled up to retract back into the housing. For instance, when the axle (111) turns in the clockwise direction, the connected landing gear legs (201) extend from the housing and when the axle (111) turns in the counterclockwise direction, the connected landing gear legs (201) retract to the housing. This is generally the case whether the axle (111) is rotated by hand via the hand crank (205) or in cases where the axle (111) is rotated electrically via a motor (101) and gearbox (107).

The shaft or axle (111) that the disclosed system is attached to may be either the existing axle that extends between the landing gear legs (201), or, depending on the needs and circumstances of the user, the user may replace the existing axle with a more optimal axle to fit their needs. Regardless of whether the system is attached to an existing or replacement axle, the disclosed system may be installed, connected, and operated in a manner that is non-invasive to manufacturer parts such that it does not void any warranty.

The system voltage will generally be either 24-Volt or 12-Volt, with a 24 to 12 volt switching capability to provide flexibility and hit performance, and the system amperage will generally be under about 300 amperes. This is illustrative only though, and other voltages and amperages are possible. For instance, in the present disclosure, voltage greater than 12 volts and less than about 48 volts is contemplated. Similarly, the present disclosure contemplates other high amperage, low voltage configurations that are suitable to provide sufficient power to lift about 30,000 lbs, up to or exceeding about 45,000 lbs, or up to or exceeding about 60,000 lbs. In addition, the present disclosure also contemplates embodiments utilizing a low current-about 30 amperes-with a specific motor and gearbox ratio to facilitate lifting about 35,000 lbs or even 45,000 lbs.

In an embodiment, the motor (101) of the present disclosure will generally be a brushless motor, which may ensure the elimination of some failure modes and allow the use of a controller. In some embodiments, the motor may be a permanent magnet AC motor (PMAC motor), an interior permanent magnet motor (IPM motor), a brushless DC electric motor (BLDC motor), or a wound DC motor. The rated torque and speed of the motor (101) may range depending on the system voltage and type of motor utilized. For example, a PMAC motor used in a 24V system may have a rated torque of about 27 nm and rated speed of about 1,000 rpm, while a PMAC motor or BLDC motor used in a 12V or 24V system may have a torque of about 9.1 nm and rated speed of about 3,000 rpm. These examples, however, are non-limiting and other types of motors, brushless or with brushes, may be used in the system, provided the motors have sufficient power, torque, and speed ratings to adequately lift the semi-trailer.

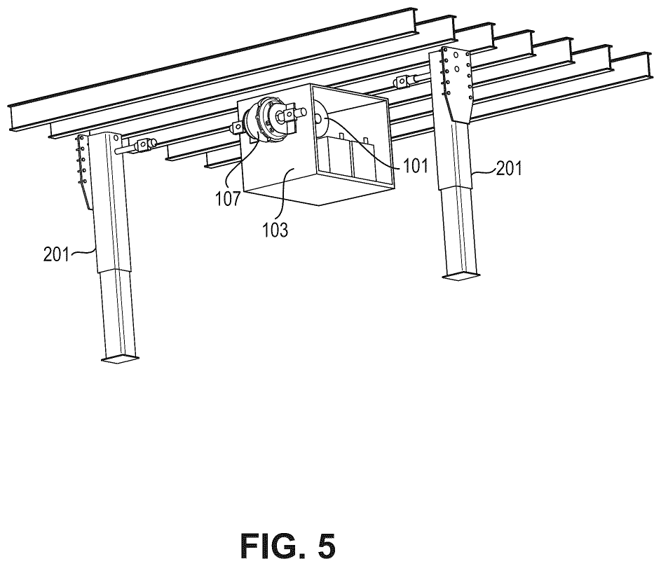

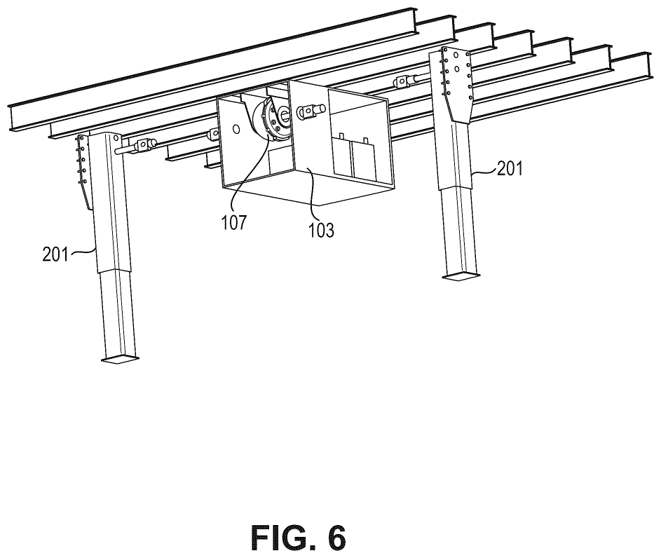

As shown in the embodiment of FIG. 6, the depicted motor housing (103) will generally be sized and shaped to house one or more motors (101), the gearbox (107), the associated gears, and other motor-related components. In some embodiments, the motor housing (103) may be configured to be located generally proximal the center of the shaft or axle (111) connecting the landing gear legs (201) and will generally be attached underneath the trailer. In such embodiments, the motor housing (103) may either fully house the motors (101), gearbox (107), associated gears, and other motor-related components, such as depicted in FIG. 6, or it may be configured such that the gearbox (107) is positioned external to the motor housing (103), such as depicted in FIG. 5.

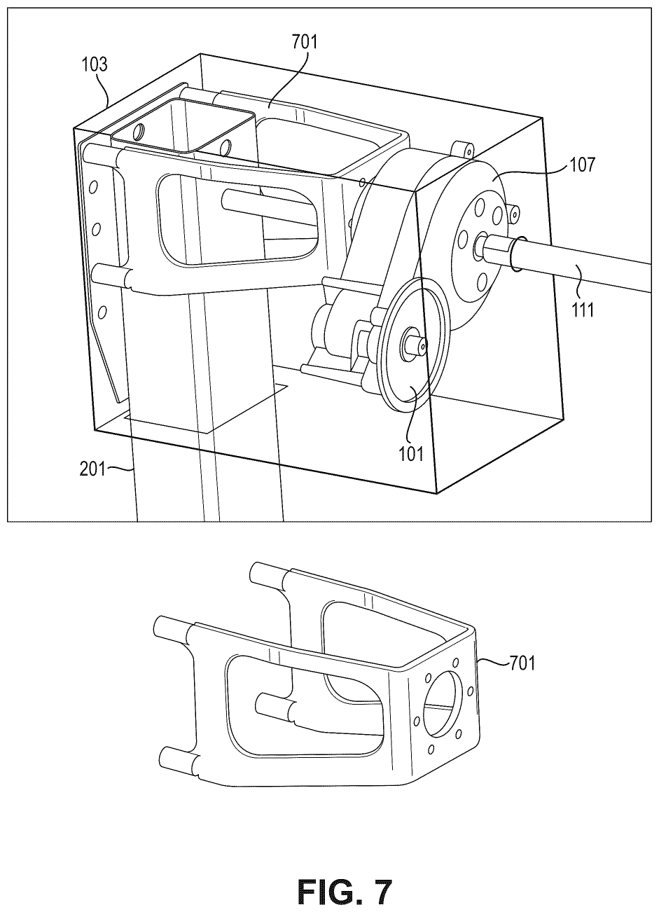

But this is not required and in other embodiments, the motor housing (103) may be configured to be located on a distal end of the axle (111), in proximity to a landing gear leg (201), as depicted in FIG. 4. In embodiments with the motor housing (103) configured on a distal end of the axle (111), the motor housing (103) may further comprise a connecting element (701) that attaches to a landing gear leg (201), as shown in FIG. 7, or the housing (103) may be configured to attach directly to a landing gear leg (201), as shown in FIG. 4. Regardless of the positioning of the motor housing (103), it will generally be constructed of material that is sufficiently durable and robust to withstand extreme weather and elements, such as heavy rain, snow, sleet, ice, salt, sand, and debris.

In the embodiment depicted in the FIGS, the gearbox (107) will generally be located in proximity to the motor (101), allowing the gearbox (107) to connect to the motor (101). As discussed above and depicted in FIGS. 6, the gearbox (107) of some embodiments may be positioned internal to the motor housing (103) or may be positioned external to the motor housing (103), but in any case it will generally be close to the motor (101). The gearbox (107) may be a parallel axis gearbox or a planetary gearbox, but other types of gearboxes, such as right angle gearbox or others that are compatible with the motor (101) and suitable for use in a landing gear system are possible, depending on the needs and circumstances of the user.

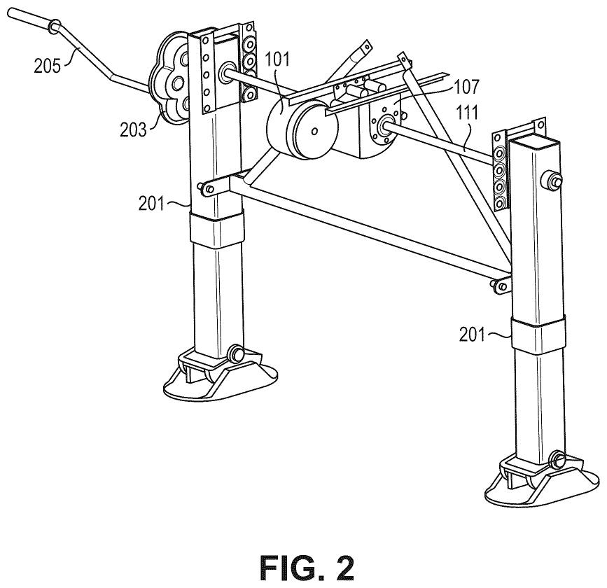

In embodiments including a parallel axis gearbox, the gears may be spur gears or helical gears, and the gearbox (107) may generally be positioned in the center of the shaft (111) in a position with sufficient offset to allow the shaft, or axle, between the landing gear legs (201) to be engaged without obstruction, as depicted in FIGS. 2 and 3, which may permit simpler retro-fitting with minimal costs and avoidance of voiding warranties. In embodiments with a planetary gearbox (107), gearbox (107) may also be positioned generally in the center of the shaft (111), with the associated motor (101) generally including a through hole and providing for high numeric ratios which may reduce the motor rating and be very compact. The gearbox (107) may further be a two-stage gearbox that exceeds a 16:1 gear ratio, a two-stage gearbox that exceeds a 21:1 gear ratio, or a triple reduction gearbox with gear ratios up to 200:1. Further, the gearbox (107) may be used in conjunction with other gearboxes for reduction, if necessary, and the gearbox (107), or combination of multiple gearboxes (107) may be selected based on user preferences, such as raising and lowering times.

The gearbox (107) connecting to the motor (101), as described above, and also connecting to the axle (111) may allow the motor (101) to transfer power to the gearbox (107), which may cause the axle (111) to rotate. As described above, rotating the axle (111) generally results in the landing gear legs retracting or extending, depending on the direction rotated. Thus, the motor (101) drives the gearbox (107) which then drives the landing gear legs (201).

In some embodiments, the gearbox (107) may be retrofitted with incumbent landing gear systems, which may allow for both legs (201) of the landing gear to operate as before and may also allow for the existing cross-shaft or axle (111) to be used. Alternatively, the cross-shaft of the existing landing gear system may be replaced to accommodate the gearbox (107).

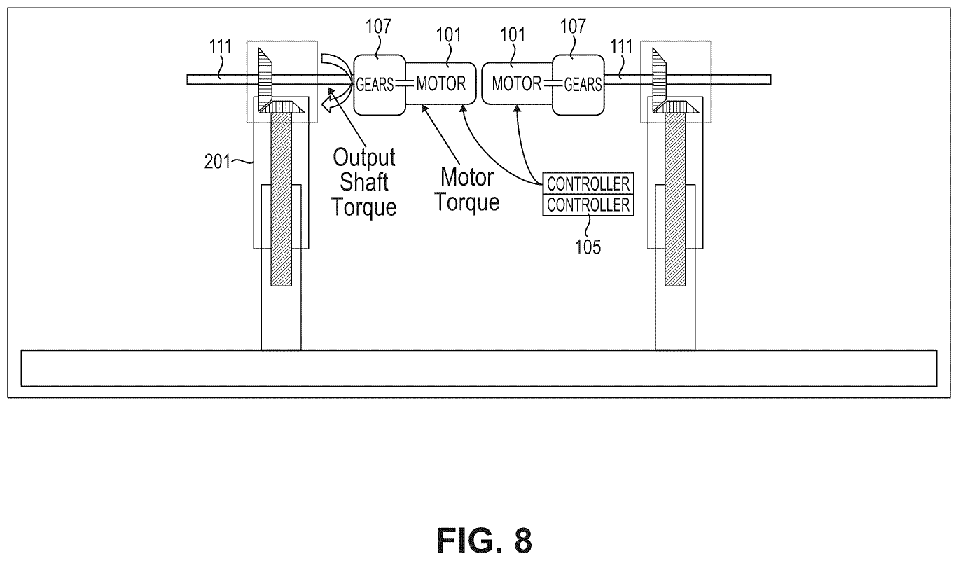

In other embodiments, the disclosed system may include two independent gearboxes (107), one driving one landing gear leg and the second driving a second landing gear leg, with both gearboxes (107) being in sync with one another, as depicted in FIG. 8. In such an embodiment, the system may have two or more motors (101) as well, with one motor (101) connecting with one gearbox (107) and a second motor (101) connecting with a second gearbox (107).

In some embodiments, the gearbox (107) may further use a differential to facilitate even landing gear loading across the landing gear legs (201) on uneven surfaces, such that the gearbox (107) may detect when the landing gear legs are not level and may self-level. Further, some embodiments of the gearbox (107) may provide inputs to the controller (105) and also may be controlled by the controller (105), as discussed further herein. In any case, the existing landing gear gearbox will generally remain in place to permit manual operation of the landing gear via the hand crank (205), if necessary.

One unique aspect of an embodiment of the motorized landing gear (100) of the present disclosure is that the gearbox (107), in conjunction with the controller (105), will preferably drive both landing gear legs (201) simultaneously. This differs from existing systems, which generally only drive one leg of the landing gear at a time or require a controller on each landing gear leg. Driving both landing gear legs (201) simultaneously may reduce the time to extend or retract the legs, reduce wear on motor by reducing the time the motor (101) is operated, and may improve leveling of the landing gear legs (201) when the legs are extended.

In some embodiments, the controller (105) may be an AC or DC controller, depending on the type of motor used, and the controller (105) may further act as an inverter from AC to DC. The controller (105) of some embodiments comprises a computer including a processor and/or a micro processor running appropriate software. In other embodiments, the controller (105) may include a dedicated circuit, such that it does not require running software, or the controller (105) may be purely mechanically operated. In more embodiments, the controller (105) may be integrated into the system to work in concert with the motor (101) and gearbox (107) to raise and lower the landing gear legs (201) and trailer (SSS). The controller (105) for embodiments that include two or more motors (101) and/or gearboxes (107), such as depicted in FIG. 8, may be configured to control the two or more motors (101) to drive the two gearboxes (107), either simultaneously or in series, to raise or lower the landing gear legs (201) simultaneously or individually.

Throughout this disclosure, the term “computer” describes hardware that generally implements functionality provided by digital computing technology, particularly computing functionality associated with microprocessors. The term “computer” is not intended to be limited to any specific type of computing device, but it is intended to be inclusive of all computational devices including, but not limited to: controllers, processing devices, microprocessors, personal computers, desktop computers, laptop computers, workstations, terminals, servers, clients, portable computers, handheld computers, smart phones, tablet computers, mobile devices, server farms, hardware appliances, minicomputers, mainframe computers, video game consoles, handheld video game products, and wearable computing devices including, but not limited to eyewear, wrist wear, pendants, and clip-on devices.

It is well-known to hose of ordinary skill in the art that some devices that are not conventionally thought of as “computers” nevertheless exhibit the characteristics of a “computer” in certain contexts. Where such a device is performing the functions of a “computer” as described herein, the term “computer” includes such devices to that extent.

It is also well known to those of ordinary skill in the art that the functionality of a single computer may be distributed across a number of individual machines. This distribution may be functional, as where specific machines perform specific tasks; or, balanced, as where each machine is capable of performing most or all functions of any other machine and is assigned tasks based on its available resources at a point in time. Thus, the term “computer” as used herein, may refer to a single, standalone, self-contained device or to a plurality of machines working together or independently, including without limitation: a network server farm, “cloud” computing system, software-as-a-service, or other distributed or collaborative computer networks.

The controller (105) of certain embodiments of the present disclosure may control and operate the landing gear system (101) to establish appropriate speed for raising and lowering the landing gear legs (201) and may measure or determine the weight of the trailer based on the current draw. For instance, the controller (105) of such embodiments may command the speed of the motor to be 4,000 RPM if the controller (105) determines the current required is 50 amperes or less, which is the condition that commonly occurs when the landing gear legs (201) are extended or retracted while the trailer is connected to a tractor with the landing gear legs (201) positioned off the surface underneath. Similarly, the controller (105) of these embodiments may command a motor speed of 2,000 RPM if the controller (105) determines the current is greater than 50 amperes, which is the condition that commonly occurs when the landing gear legs (201) are extended to the ground to support the trailer. Further, the controller's (105) speed determination and weight measurement or determination may be calibratable to ensure accurate determinations and measurements.

Some embodiments of the controller (105) may generally raise and lower the landing gear legs (201) with a variable speed. For instance, when the landing gear legs (201) are being lowered, the controller (105) of such embodiments may increase the speed of such lowering until the legs interact with the surface underneath, which may be determined based on an increased torque load. When the controller (105) determines the landing gear legs (201) have touched the surface underneath, the controller (105) may then reduce the speed of the legs (201) being lowered depending on current draw, torque load, weight or loading of the trailer, or a combination thereof. Similarly, as the landing gear legs (201) are being raised, the controller (105) may begin raising the legs (201) at a slower speed until the controller (105) determines the legs are no longer in contact with the surface underneath, and then the controller (105) may increase the speed of the legs (201) being raised.

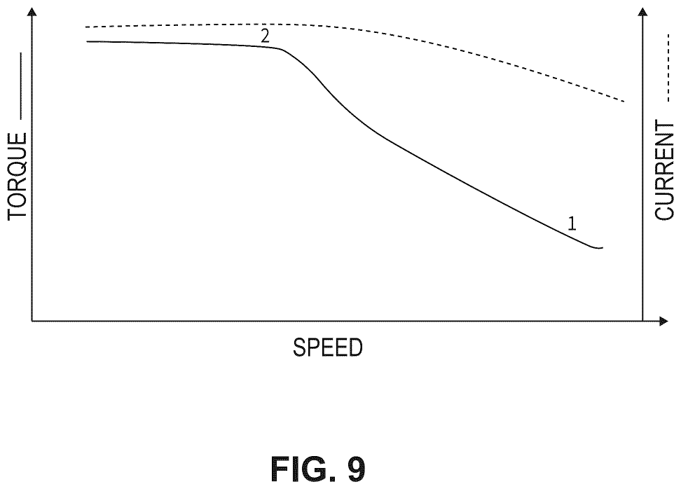

Furthermore, in the embodiments of the controller (105) including this variable speed, the controller (105) may command a prescribed ramp down stop that gradually decreases the motor voltage until the motor (101) comes to a full stop. This prescribed ramp down features is illustratively depicted in the graph of FIG. 9, which shows the gradually ramp down in speed, torque, and current. Without this ramp down features, these parameters-speed, torque, and current-would have a sudden drop when the motor is stopped, and such a sudden drop could cause the axle to shear. This prescribed ramp down stop may be conducted when the controller (105) determines the current is greater than a prescribed current upper limit for more than a prescribed time upper limit with the speed of the motor (101) at 0 RPM.

The prescribed current upper limit for a fully loaded trailer may be greater than 70 amperes, greater than 80 amperes, greater than 200 amperes, or other current limit values, depending on the needs and circumstances that the system is used in. The prescribed current upper limit for a unloaded trailer may be greater than 35 amperes, greater than 40 amperes, greater than 50 amperes, or other current limit values, depending on the needs and circumstances that the system is used in. However, the upper current limit may vary depending on the weight of the trailer.

Likewise, the prescribed time upper limit may be less than about 1 second, about 300 milliseconds, about 400 milliseconds, about 500 milliseconds, about 600 milliseconds, or more, depending on the needs and circumstances that the system is used in. This condition commonly occurs when the landing gear legs (201) are fully extended or retracted and hit a mechanical stop. This prescribed ramp down stop feature may prevent the shaft (111) from shearing, which often occurred with existing motorized landing gear systems when the landing gear legs fully extend or retract due to the abrupt halt in motion of the shaft when the mechanical stop is hit.

In other embodiments, the lowering and raising speed of the legs (201) may be determined by the controller (105) based on the current draw, torque load, weight or loading of the trailer, or a combination thereof, or may be determined based on a user choosing a desired raise and lower duration. However, as discussed further herein, some embodiments of the controller (105) may include certain safety features to ensure the system does not get damaged and such safety features may provide certain restrictions on how quickly or slowly the landing gear legs are raised and lowered. For instance, in certain embodiments, the controller (105) may have a minimum and maximum duration the legs can be raised and lowered that the user may choose from. The controller (105) of some embodiments will generally also ensure the speed of raising and lowering the landing gear legs (201) is consistent and such a speed will generally equate to the legs (201) being raised or lowered within about one minute.

In some embodiments, the controller (105) may also be preprogrammed with preset heights for raising and lowering the landing gear legs (201). In such embodiments, the manufacturer may configure the preset height based on a standard height of a known tractor with a known trailer, which may be useful for use in a fleet of tractor-trailers. Alternatively, during installation of the system the operator may select a preset height from a list of preprogrammed heights that are included in some embodiments of the controller (105) during manufacturing. In other embodiments, the controller (105) may include a display screen and the user may scroll through the list of preprogrammed heights to select the appropriate height. In still other embodiments, the selection of the preset height may be accomplished by the user scanning a QR code, bar code, or other scannable code that contains the relevant height information for the particular tractor-trailer. In further embodiments, the operator may set a custom height during installation and select that custom height to be the preset height limits for operation of the system.

The controller (105) may also include various safety features in some embodiments, which may protect the system, the trailer, or the operator. For instance, it is preferred for the controller (105) to include an interlock to prevent dropping the landing gear while the vehicle is in motion. This feature may use an accelerometer that, when sufficient motion is detected, sends a signal to the controller (105) which then may lock the landing gear in position or otherwise prevent it from dropping. Additionally, it is preferred for the controller (105) to prevent the landing gear legs (201) from extending or retracting too far by establishing a minimum and maximum extension and retraction limit. The limit of minimum and maximum extension and retraction may be based on the preset heights, if the controller (105) was programmed to include preset heights. If the controller (105) was not programmed with preset heights, the minimum and maximum height limits may be based on the standard height of a tractor-trailer or by other means sufficient to ensure the legs are not extended or retracted too far. In addition, the controller (105) may contain a leveling element to assist in leveling the landing gear legs, which may be beneficial to both ensure the trailer is level to prevent load shifting events. The controller (105) ensuring the trailer is level may be particularly beneficial in situations where the landing gear legs (201) are extended on an uneven surface.

Furthermore, the embodiments of the controller (105) establishing an appropriate speed of moving the landing gear legs (201), as discussed previously, in addition to assisting with performance of the system, may provide additional protections for the system, trailer, and operator. For instance, the speed control determination may ensure the system is not raising too quickly, which may damage the gears of the system, and simultaneously ensure the system is not raising too slowly, causing an unreasonable wait time for the system to reach the desired height. Similarly, the speed control may ensure the system does not lower too quickly, which may cause load shifting that could damage the tractor-trailer or injure a nearby person, while simultaneously ensuring the system does not lower too slowly, which may cause binding of the gears from increased stress on the teeth of the gears.

In addition to the above safety features, the controller (105) may also monitor various other operational data to prevent damage to the motor. For instance, in some embodiments, the controller (105) may monitor the current draw or torque load on the system, or may be connected to other components to provide additional monitoring capabilities. One non-limiting example of such a component is a thermocouple to monitor the temperature and provide overheating protection. The controller (105) in other embodiments may further include built-in redundancy for any or all of the included safety features for added protection and to prevent a singe point of failure from inhibiting or removing a safety feature.

In addition, in the event of the controller (105) failing, or simply by choice of the user, the controller (105) of the present disclosure may be manually bypassed by the user. This bypass feature may be controlled by a positioning a multi-position switch (113) to a bypass position, or it may be automatically enacted in the event of a power failure or other failure of the controller (105). The switch controlled bypass option may allow for the user to bypass the controller (105) and operate the landing gear legs manually with a hand crank, by methods known in the art, if the user desires.

When the system is installed, and after the user has set the speed and height levels, as described above, the user may operate the system via the multi-position switch (113), as depicted in FIG. 1. The depicted multi-position switch (113) may include the bypass position, as described above, a raise position, and a lower position. When the user desires to lower the landing gear legs (201), the user positions the depicted switch (113) to the lower position and the controller (105) will lower the legs (201) at the set speed and to the set height levels, as described above. Likewise, when the user desires to raise the landing gear legs (201), the user positions the depicted switch (113) to the raise position and the controller (105) will raise the legs (201) at the set speed and to the set height, as described above.

In further embodiments, the controller (105) may be configured to provide warnings or indications when a monitored parameter exceeds a predetermined limit, when a safety feature is enabled, when the controller (105) is bypassed, or in the event of a controller (105) failure. For instance, in such embodiments, if the controller (105) determines the speed of the system raising is too quick, the system may simultaneously reduce the speed of the raising and provide a warning or indication. Likewise, if the controller (105) determines the gears of the landing gear are at risk of binding or are binding, the controller (105) may either cause the landing gear legs to stop moving or may send a warning or indication, or both. The controller (105) of these embodiments may similarly send a warning or indication if the controller (105) determines or detects that the current draw or torque load on the system exceeds a threshold limit, or if the controller (105) loses input of one or more of its monitored parameters.

The warnings or indications sent, made, or provided from the controller (105) may be in the form a visual indication by means of a light on the controller (105) itself, or the system may be configured to display a visual indication in the cab of the trailer (SSS). Alternatively, or additionally, the controller (105) in some embodiments may be configured to wirelessly communicate with a user's mobile communication device via Bluetooth® or Wifi and may send an indication of the monitored parameter being exceeded to the mobile communication device.

For purposes of this disclosure, the user's “mobile communication device” will generally be considered a special type of computer. The mobile communication device may be, but is not limited to, a smart phone, tablet PC, e-reader, satellite navigation system (“SatNav”), fitness device (e.g., a Fitbit™ or Jawbone™) or any other type of mobile computer whether of general or specific purpose functionality. Generally speaking, a mobile communication device is network-enabled and communicating with a server system providing services over a telecommunication or other infrastructure network. A mobile communication device is essentially a mobile computer, but one which is commonly not associated with any particular location, is also commonly carried on a traveler's person, and usually is in constant communication with a network.

In additional embodiments, the controller (105) may have a display screen that indicates when a parameter is being exceeded. In other embodiments, the indication may be sent to a user's mobile communication device and also displayed on the controller's (105) display screen may include. In further embodiments, the indication may be sent to either a user's mobile communication device or may be displayed on the controller's (105) display screen. The information sent to a user's mobile communication device and/or displayed on the controller's (105) display screen may include: the parameter monitored; the setpoint of the parameter; the measured/monitored value of the parameter; or other information.

In more embodiments, the controller (105) may further be configured to interface with or connect to, directly or wirelessly via Bluetooth® or Wifi, a Controller Area Network (CAN). The system of these embodiments may then be integrated to the tractor, driver, or management of the unit to allow for remote control operation of the controller (105) and for remote viewing or monitoring of system parameters. For example, the system may allow for, among other things, remote monitoring of the loading status of the trailer (i.e., whether there is a load identified or no load identified), the weight of the trailer, the power source (i.e., battery or battery charger, as described further herein), or the health of the power source (e.g., percentage of battery-life remaining, potential malfunctions with the battery charger, unanticipated power usage of the system, etc.). The system of these embodiments may further allow for remote notifications or warnings when a monitored parameter exceeds a predetermined value, as described above, and may provide remote monitoring of that parameter.

Another unique aspect of certain embodiments of the system of the present disclosure are the safety features and control aspect of the controller (105). For instance, as described above, the variety of safety features of some embodiments of the controller (105) not only assist in the system raising and lowering the landing gear legs at an appropriate speed, but also may prevent binding of the gears, ensure the trailer is not raised or lowered too quickly or too slowly, ensure the trailer is level when the landing gear legs (201) are extended, and provides various information on the system operation to the user or others, which may be beneficial if a need for troubleshooting the system arises.

An additional unique element of the disclosed motorized landing gear (100) is the power source (109). The power source (109) of the embodiment depicted in FIG. 1 may be a battery or battery charger, may be AC or DC, and the battery charger may be powered from the existing 12-Volt power supply in the tractor-trailer, but this is not required and in other embodiments, the power source (109) may be supplied via a solar panel or from existing power in the semi-tractor-trailer. The power source (109) for the depicted system may be swapped from the battery to the battery charger via a manual switch, or the system may automatically swap between the battery and battery charger based on the charge on the battery or other parameters. The system of some embodiments can be powered by either the battery or battery charger because the controller (105) generally includes an AC to DC inverter, as discussed above.

Comparatively, existing motorized landing gear systems, especially those capable of lifting a trailer weighing over 20,000 lbs, typically require a 24-Volt power supply, which can be problematic because tractor-trailers are generally equipped with a 12-Volt power supply. Some existing motorized landing gear systems can be powered off a 12-Volt power supply, but these systems are unable to lift a loaded trailer (which can weigh from 20,000 lbs to over 60,000 lbs) because they typically have a lifting capacity of less than about 12,000 lbs. Resultingly, existing motorized landing gear systems either cannot lift a loaded trailer, require a motorized system on each landing gear leg, and/or require a 24-Volt power supply. Conversely, the disclosed system improves existing systems by allowing a loaded trailer to be lifted with one system installed (i.e., the disclosed system does not require one system on each landing gear leg in order to lift a loaded trailer) and allowing a 12-Volt power supply to be used.

The qualifier “generally” and similar qualifiers, as used in the present case, would be understood by one of ordinary skill in the art to accommodate recognizable attempts to conform a device to the qualified term, which may nevertheless fall short of doing so. This is because terms such as “cylinder” are purely geometric constructs and no real-world component is a true “cylinder” in the geometric sense. Variations from geometric and mathematical descriptions are unavoidable due to, among other things, manufacturing tolerances resulting in shape variations, defects and imperfections, non-uniform thermal expansion, and natural wear. Moreover, there exists for every object a level of magnification at which geometric and mathematical descriptors fail due to the nature of matter. One of ordinary skill would thus understand the term “generally,” and relationships contemplated herein regardless of the inclusion of such qualifiers, to include a range of variations from the literal geometric meaning of the term in view of these and other considerations.

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

It will further be understood that any of the ranges, values, properties, or characteristics given for any single component of the present disclosure can be used interchangeably with any ranges, values, properties, or characteristics given for any of the other components of the disclosure, where compatible, to form an embodiment having defined values for each of the components, as given herein throughout. Further, ranges provided for a genus or a category can also be applied to species within the genus or members of the category unless otherwise noted.

1. A motorized landing gear comprising:
a motor housing, said motor housing enclosing a motor;
a gearbox;
a controller; and
a power source powering said motor and said controller;
said gearbox attaching to an axle having two ends;
wherein a first end of said axle connects to a first landing gear leg and a second end of said axle connects to a second landing gear leg;
wherein said motor connects to said gearbox;
wherein said controller instructs said motor to rotate, said rotation of said motor transfers power to said gearbox to rotate said axle;
wherein said rotation of said axle in a first direction simultaneously telescopes said landing gear first leg and said landing gear second leg; and
wherein said rotation of said axle in a second direction simultaneously retracts said landing gear first leg and said landing gear second leg.

2. The motorized landing gear of claim 1, further comprising a hand crank rotating said axle to telescope and retract said first and second landing gear legs.

3. The motorized landing gear of claim 1, wherein said controller instructs said motor to rotate to move said landing gear legs at a variable speed.

4. The motorized landing gear of claim 3, wherein said variable speed increases when said landing gear legs are distal the ground surface and said variable speed decreases when said landing gear legs are proximal the ground surface.

5. The motorized landing gear of claim 3, wherein said controller determines the speed to instruct said motor to rotate based on current draw, torque load, or load weight.

6. The motorized landing gear of claim 3, wherein said controller instructing said motor to rotate at a variable speed includes a prescribed ramp down stop; and wherein said prescribed ramp down stop is initiated when the controller determines the current is greater than a prescribed current upper limit for more than a prescribed time limit with the speed of the motor at 0 RPM.

7. The motorized landing gear of claim 1, wherein said gearbox further comprises use of a differential that levels said landing gear legs on uneven surfaces.

8. The motorized landing gear of claim 1, wherein said power source is supplied from a semi-trailer electrical system.

9. The motorized landing gear of claim 1, wherein said power source is supplied from a solar panel.

10. The motorized landing gear of claim 1, wherein said gearbox is chosen from the group consisting of: a parallel axis gearbox, a planetary gearbox, and right angle gearbox.

11. A method of retro-fitting an existing landing gears, the method comprising:
providing an existing landing gear comprising a first landing gear leg and a second landing gear leg attached to a semi-trailer;
said first landing gear leg and said second landing gear leg connecting to first and second ends of an axle, respectively;
attaching a gearbox to said axle;
connecting a motor to said gearbox, said motor transferring power to said gearbox to rotate said axle;
rotating said axle in a first direction to simultaneously telescope said landing gear first leg and said landing gear second leg; and
rotating said axle in a second direction to simultaneously retract said landing gear first leg and said landing gear second leg.

12. The method of claim 11, wherein cranking a hand crank telescopes and retracts said landing gear legs.

13. The method of claim 11, further comprising said controller instructing said motor to rotate to move said landing gear legs at a variable speed.

14. The method of claim 13, wherein said variable speed increases when said landing gear legs are distal the ground surface and said variable speed decreases when said landing gear legs are proximal the ground surface.

15. The method of claim 13, further comprising said controller determining the speed to instruct said motor to rotate based on current draw, torque load, or load weight.

16. The method of claim 13, wherein said controller instructing said motor to rotate at a variable speed includes a prescribed ramp down stop; and wherein said prescribed ramp down stop is initiated when the controller determines the current is greater than a prescribed current upper limit for more than a prescribed time limit with the speed of the motor at 0 RPM.

17. The method of claim 11, wherein said gearbox uses a differential to level said landing gear legs on uneven surfaces.

18. The method of claim 11, wherein said power source is supplied from a semi-trailer electrical system.

19. The method of claim 11, wherein said power source is supplied from a solar panel.

20. The method of claim 11, wherein said gearbox is chosen from the group consisting of: a parallel axis gearbox, a planetary gearbox, and right angle gearbox.
